(19) United States
(12) Patent Application Publication
(10) Pub. No.: US 2016/0321441 A1
(43) Pub. Date: Nov. 3, 2016

(54) SECURE BIOMETRIC AUTHENTICATION

(71) Applicant: Synaptics Incorporated, San Jose, CA (US)

(72) Inventor: Smbat Tonoyan, San Jose, CA (US)

(21) Appl. No.: 14/985,123

(22) Filed: Dec. 30, 2015

Related U.S. Application Data
(60) Provisional application No. 62/156,017, filed on May 1, 2015.

(51) Int. Cl. G06F 21/32; G06F 21/74

(52) U.S. Cl. CPC G06F 21/32; G06F 21/74

(57) ABSTRACT

Systems and methods for configuring an authenticator to provide a secure user authentication to an application processing a task requesting the authentication are provided. The authenticator performs the biometric authentication upon receiving a match request from an application processing the task. Subsequently, the authenticator generates a match score based on a comparison between biometric input data captured by a sensor associated with the authenticator and stored enrollment data in order to determine a match result based on the match score. The authenticator then determines a level of confidence in the match result and provides the match result and the level of confidence to the application processing the task. Additionally, systems and methods provide a secure way to communicate the match result and the level of confidence over an untrusted communication channel.

### FIELD

This disclosure relates generally to the field of authentication and, more specifically, to systems and methods for secure biometric authentication.

### BACKGROUND

Electronic user authentication is used for a variety of tasks, such as electronic banking, payment transactions, device unlock, file access, and other uses. One solution to provide electronic user authentication is biometric matching, which is a form of biometric authentication. Biometric authentication provides a reliable and convenient method to verify a user's identity. Moreover, in certain instances, biometric authentication also allows for new functionality based on the recognition of different biometrics of the same user. For example, fingerprint matching can be used to identify which finger a particular user is using to add further customization.

Advances in biometric sensing technology have allowed for increased adoption of biometric authentication in a variety of electronic devices, including mobile devices, laptops, wearable gear, and the like. However, secure and reliable implementation of biometric authentication in these devices remains a challenging task. For example, if the biometric sensor is a fingerprint sensor, it is possible that another person (i.e., an “imposter”) has a similar enough fingerprint to the fingerprint of the correct user so that the imposter is able to authenticate with his or her own fingerprint. This phenomenon is referred to as a “false acceptance.” The rate at which false acceptance occurs for a given authentication scheme is referred to as the “false acceptance rate” (FAR). The rate at which false rejection occurs for a given authentication scheme is referred to as the “false rejection rate” (FRR).

FAR/FRR requirements may vary depending on the task for which the biometric authentication is being performed. For instance, a biometric authentication for electronic banking or processing a payment transaction may have more demanding FAR/FRR requirements then other tasks. Accordingly, what is considered a reliable biometric authentication may vary depending on the task for which user authentication is being performed.

Moreover, a communication channel for communicating the biometric authentication to an application performing the task requesting the user authentication may be considered an untrusted communication channel. An untrusted communication channel is susceptible to an attack, such as a data replaying attack or an attack maliciously modifying the user authentication. Accordingly, securing the communication channel is a concern when providing the user authentication.

In view of the above, there is a need for secure and reliable biometric authentication. These and other advantages of the disclosure, as well as additional features, will be apparent from the description of the disclosure provided herein.

### SUMMARY

One embodiment of the disclosure provides a method for an authenticator to provide a secure biometric authentication for a task. The method includes receiving a match request from an application processing the task and generating a match score based on a comparison between biometric input data captured by a sensor associated with the authenticator and stored enrollment data. The method further includes determining a match result based on the match score and determining a level of confidence in the match result. And the method further includes providing the match result and the level of confidence to the application processing the task.

Another embodiment of the disclosure provides a device for providing a secure biometric authentication for a task. The device includes a biometric sensor and a processing system including an authenticator. The authenticator is configured to receive a match request from an application processing the task; generate a match score based on a comparison between biometric input data captured by a sensor associated with the authenticator and stored enrollment data; determine a match result based on the match score; determine a level of confidence in the match result; and provide the match result and the level of confidence to the application processing the task.

Another embodiment of the disclosure provides a system providing a secure biometric authentication for a task. The system includes an application processing the transaction request and an authenticator. The authenticator is configured to receive a match request from the application; generate a match score based on a comparison between biometric input data captured by a sensor associated with the authenticator and stored enrollment data; determine a level of confidence in the match score; and provide the level of confidence to the application.

### BRIEF DESCRIPTION OF THE DRAWINGS

FIG. 1 is a block diagram of an example of a system that includes a sensor and a processing system, according to an embodiment of this disclosure;

FIG. 2 is a block diagram of a biometric authenticator in communication with an application according to an embodiment of this disclosure;

FIG. 3 is a schematic diagram depicting a secure authentication method according to an embodiment of this disclosure;

FIG. 4 is a flow chart depicting steps performed by an authenticator for providing a secure biometric authentication according to an embodiment of this disclosure;

FIG. 5 is a flow chart depicting steps for providing the secure authentication method of FIG. 3;

FIG. 6 is a block diagram of an electronic system having a biometric authenticator in communication with an embedded secure element according to an embodiment of this disclosure;

FIG. 7 is a block diagram of an electronic system having a secure processor in communication with an application processor according to an embodiment of this disclosure; and

FIG. 8 is a block diagram of an electronic system having a host processor in communication with an application processor according to an embodiment of this disclosure.

### DETAILED DESCRIPTION

The following detailed description is exemplary in nature and is not intended to limit the invention or the application and uses of the invention. Furthermore, there is no intention to be bound by any expressed or implied theory presented in the preceding technical field, background, summary, brief description of the drawings or the following detailed description.

Biometric authentication uses biometric matching in order to authenticate a user of a device or system incorporating a biometric sensor. Biometric authentication of the user of the device or system is useful for performing a variety of tasks, such as device unlock, file access, electronic banking, processing a payment transaction and other such tasks. In performing each of these tasks, an application performing that task requests the biometric authentication from a biometric authenticator by sending a match request to the authenticator. The biometric authentication is performed by determining a match score between a previously collected biometric sample from the user and a recently collected biometric sample. The match score is then compared to a threshold to determine a match result, which indicates whether the previously collected biometric sample and recently collected biometric sample are from the same user. Additionally, the authenticator will determine a level of confidence in that match result. The level of confidence provides a metric for determining an amount of confidence the application performing the task requesting the biometric authentication can place in the match result. After determining the match result and the level of confidence in the match result, the authenticator provides that match result and the level of confidence to the application performing the task. Further, in certain embodiments, a secure method is utilized for the communication of the match result between the authenticator and the application.

Turning to the drawings, and as described in greater detail herein, embodiments of this disclosure include devices, systems and methods for communicating a biometric match result to another party (e.g., application, server) securely and reliably, through an untrusted communication channel. This allows the entity requesting user authentication to verify the authentication result and make sure it is generated by a known and trusted authenticator. This provides a secure and reliable approach for integrating a biometric authenticator into different security applications requiring user authentication, such as mobile payment applications.

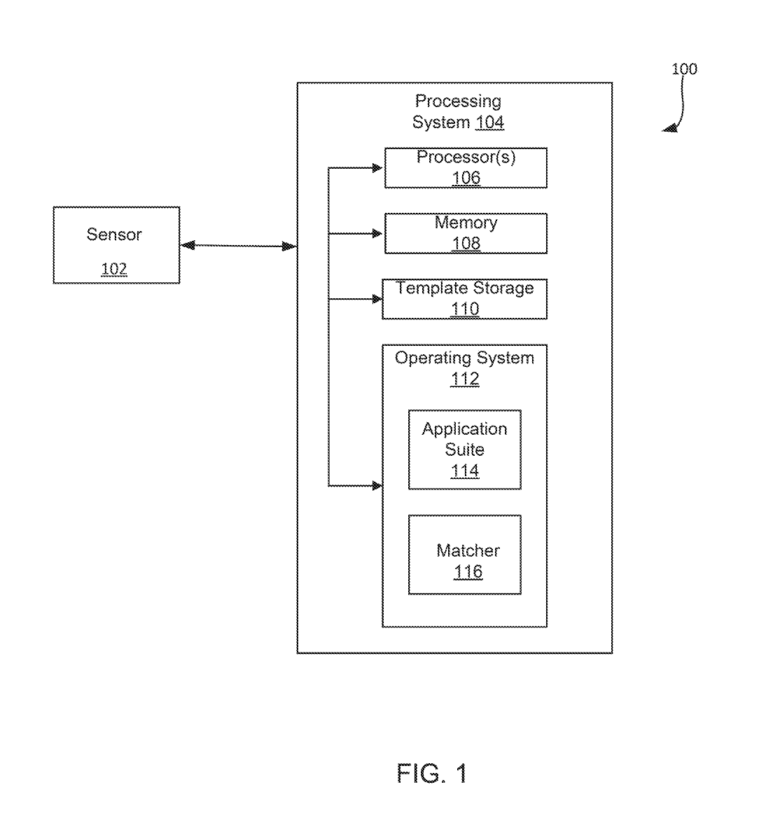

FIG. 1 illustrates a block diagram of an electronic system or electronic device 100 that includes an input device, such as sensor 102, and processing system 104, in accordance with an embodiment of the disclosure. As used in this document, the term “electronic system” (or “electronic device”) broadly refers to any system capable of electronically processing information. Some non-limiting examples of electronic systems include personal computers of all sizes and shapes, such as desktop computers, laptop computers, netbook computers, tablets, web browsers, e-book readers, and personal digital assistants (PDAs). Additional example electronic devices include composite input devices, such as physical keyboards and separate joysticks or key switches. Further example electronic systems include peripherals such as data input devices (including remote controls and mice), and data output devices (including display screens and printers). Other examples include remote terminals, kiosks, and video game machines (e.g., video game consoles, portable gaming devices, and the like). Other examples include communication devices (including cellular phones, such as smart phones), and media devices (including recorders, editors, and players such as televisions, set-top boxes, music players, digital photo frames, and digital cameras). Additionally, the electronic device 100 could be a host or a slave to the sensor 102.

Sensor 102 can be implemented as a physical part of the electronic device 100, or can be physically separate from the electronic device 100. As appropriate, the sensor 102 may communicate with parts of the electronic device 100 using any one or more of the following: buses, networks, and other wired or wireless interconnections. Examples include I2C, SPI, PS/2, Universal Serial Bus (USB), Bluetooth, RF, and IRDA.

In some embodiments, sensor 102 will be utilized as a biometric sensor, such as a fingerprint sensor utilizing one or more various electronic fingerprint sensing methods, techniques and devices to capture a fingerprint image of a user. In other embodiments, other types of biometric sensors or input devices may be utilized instead of or in addition to the fingerprint sensor to capture a biometric sample. For instance, input devices that capture other biometric data such as faces, vein patterns, voice patterns, hand writing, keystroke patterns, heel prints, body shape, and/or eye patterns, such as retina patterns, iris patterns, and eye vein patterns may be utilized. For ease of description, biometric data discussed herein will be in reference to fingerprint data. However, any other type of biometric data could be utilized instead of or in addition to the fingerprint data.

Generally, fingerprint sensor 102 may utilize any type of technology to capture a user's fingerprint. For example, in certain embodiments, the fingerprint sensor 102 may be an optical, capacitive, thermal, pressure, radio frequency (RF) or ultrasonic sensor. Furthermore, the fingerprint sensor 102 may be two-dimensional (2D) sensor or linear sensor. In addition, the fingerprint sensor 102 may capture images based on placement-type images (also “touch” or “area” type images), or swipe-type images (also “slide” or “sweep” type images).

Turning now to the processing system 104 from FIG. 1, basic functional components of the electronic device 100 utilized during capturing and storing a user fingerprint image are illustrated. The processing system 104 includes a processor 106, a memory 108, a template storage 110 and an operating system (OS) 112 hosting an application suite 114 and a matcher 116. Each of the processor 106, the memory 108, the template storage 110 and the operating system 112 are interconnected physically, communicatively, and/or operatively for inter-component communications.

As illustrated, processor 106 is configured to implement functionality and/or process instructions for execution within electronic device 100 and the processing system 104. For example, processor 106 executes instructions stored in memory 108 or instructions stored on template storage 110. Memory 108, which may be a non-transitory, computer-readable storage medium, is configured to store information within electronic device 100 during operation. In some embodiments, memory 108 includes a temporary memory, an area for information not to be maintained when the electronic device 100 is turned off. Examples of such temporary memory include volatile memories such as random access memories (RAM), dynamic random access memories (DRAM), and static random access memories (SRAM). Memory 108 also maintains program instructions for execution by the processor 106.

Template storage 110 comprises one or more non-transitory computer-readable storage media. The template storage 110 is generally configured to store enrollment views for fingerprint images for a user's fingerprint. The template storage 110 may further be configured for long-term storage of information. In some examples, the template storage 110 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

The processing system 104 also hosts an operating system 112. The operating system 112 controls operations of the components of the processing system 104. For example, the operating system 112 facilitates the interaction of the processor(s) 106, memory 108, and template storage 110. The operating system 112 further hosts the application suite 114. The application suite 114 contains applications utilizing data stored on the memory 108 or the template storage 110 or data collected from interface devices such as the sensor 102 to cause the processing system 104 to perform certain functions. For instance, in certain embodiments, the application suite 114 hosts an enroller application, which functions to capture one or more views of the user's fingerprint. The views or fingerprint images generally contain a partial or full image of the user's fingerprint, and they may be raw images or feature sets extracted from the raw images. The enrollment application generally instructs the user to hold or swipe their finger across the sensor 102 for capturing the image. After each requested image is captured, the enrollment application typically stores the captured image in the template storage 110. In certain embodiments, the enrollment application will cause the data representing the captured image to undergo further processing. For instance, the further processing may be to compress the data representing the captured image such that it does not take as much memory within the template storage 110 to store the image.

In certain embodiments, the application suite 114 will perform a biometric authentication of a user of the electronic device 100. For example, a biometric authentication may be performed for an operating system log-on application, a screen saver application, a folder/file lock/unlock application, an application lock and a password vault application, an electronic banking or mobile payment system application or any other such application. In each of these applications, the individual application may cause the operating system 112 to request the user's fingerprint for an authentication process prior to undertaking a specific action, such as providing access to the operating system 112 during a log-on process for the electronic device 100 or to process a payment transaction via a mobile payment system hosted by the electronic device 100. In certain embodiments of the disclosure, the request will be in the form of sending a match request from the application to the processing system 104.

The matcher 116 of the operating system 112 functions to compare the fingerprint image or images stored in the template storage 110 with a newly acquired fingerprint image or images from a user attempting to utilize various applications of the electronic device 100. In certain embodiments, the matcher 116, or other process, performs image enhancement functions for enhancing a fingerprint image.

In certain embodiments, the matcher 116, or other process, is also configured to perform feature extraction from the fingerprint image or images of the user. During feature extraction, the matcher 116 extracts unique features of the user's fingerprint to derive a verification template used during matching. Various discriminative features may be used for matching, including: minutia matching, ridge matching, ridge flow matching, or some combination thereof. If authentication is performed using minutia features, the matcher 116 scans the captured view of the user's fingerprint for minutia. During extraction, the matcher 116 acquires a location and orientation of the minutia from the fingerprint and compares it to previously captured location and orientation information of minutia from the fingerprint image or images in the template storage 110.

The matcher 116 compares the recently acquired fingerprint image or images associated with a biometric authentication attempt to the enrollment template to compute a match score. If the composite match score satisfies a threshold, the matcher 116 indicates a positive match result. Otherwise, a non-match result may be indicated. It will be understood that the matcher 116 may perform comparisons for purposes other than authentication.

While many embodiments of the disclosure are described in the context of a fully functioning apparatus, the mechanisms of the present disclosure are capable of being distributed as a program product (e.g., software) in a variety of forms. For example, the mechanisms of the present disclosure may be implemented and distributed as a software program on information bearing media that are readable by electronic processors (e.g., non-transitory computer-readable and/or recordable/writable information bearing media readable by the processing system 104). Additionally, the embodiments of the present disclosure apply equally regardless of the particular type of medium used to carry out the distribution. Examples of non-transitory, electronically readable media include various discs, memory sticks, memory cards, memory modules, and the like. Electronically readable media may be based on flash, optical, magnetic, holographic, or any other storage technology.

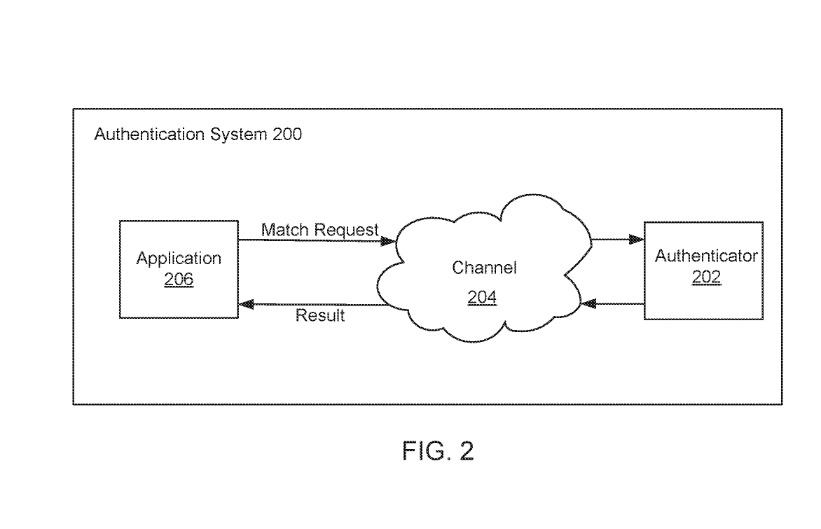

Turning now to FIG. 2, an authentication system 200 is illustrated. During a biometric authentication, the processing system 104 (see FIG. 1) of the electronic device 100 and its associated sensor 102 may be configured as an authenticator 202, where the match result determined by the matcher 116 is provided to an application 206 requesting the biometric authentication by the authenticator 202. As illustrated, this reporting may be made over a communication channel 204 to the application 206. The communication channel 204 may be untrusted. The application 206 may reside on the same physical device as the authenticator 202 or on a device remote from the authenticator 202 (e.g. a server).

In either configuration, the match result reported by the authenticator 202 should be comprehensive in that it provides information needed to identify the user of the authenticator 202 uniquely and provide measures to qualify the match result. Providing a match result that is comprehensive for the various tasks performed by applications that request the biometric authentication can require accounting for various tasks that may have different FRR/FAR requirements. Usually, in order to account for different FRR/FAR requirements, different thresholds would be needed for comparison with a match score in order to determine the match result in accordance with the desired FRR/FAR requirement. For instance, a low threshold may be desired for an unlocking application requesting a biometric authentication so as to provide good usability, while a high threshold may be desired for a payment system application in order to provide high security. However, the different thresholds may not be known to the authenticator 202 in advance.

To further complicate this process, FRR/FAR requirements for each of these tasks may vary based on requirements of a client of the authenticator 202. For example, one payment company providing an electronic banking application or a payment system for processing a payment transaction, such as a mobile payment transaction, may have different FRR/FAR requirements from another company providing a similar application.

One way to support different FRR/FAR requirements at the authenticator 202 would be to support a configurable threshold. However, supporting a configurable threshold in the authenticator 202 is a security risk. By allowing a threshold to be varied, the authenticator 202 would be exposed to an attacker in that it would provide a tool for the attacker to vary the threshold for malicious purposes.

Another way to support different FRR/FAR requirements at the authenticator 202 and to improve the reliability of the match result, is for the authenticator 202 to provide a level of confidence of the match result, which provides a metric for determining an amount of confidence the application performing the task requesting the biometric authentication can place in the match result. The level of confidence is provided to the application by the authenticator 202 along with the match result. In this manner, the various applications performing certain tasks can use the level of confidence accompanying the match result to determine when the desired FAR/FRR requirement is met for that task.

For example, in an application providing a payment system processing a transaction, the FAR/FRR requirement will typically be more rigorous then certain other tasks. Accordingly, when an application requesting a biometric authentication receives the match result and the level of confidence, the application will be able to utilize the level of confidence in order to determine whether the match result meets its requirements for FAR/FRR.

Additionally, providing the application performing the task with the level of confidence allows the application to support different policies based on the level of confidence. For example, in processing a payment transaction, if the level of confidence is low, the application may accept a relatively low payment amount request, for better usability, but reject a relatively high payment amount transaction and request the user to provide additional authentication data, such as a further biometric scan of the same type of biometric (e.g., a second fingerprint scan) or a different type of biometric (e.g., facial recognition scan in addition to a fingerprint), or a different authentication factor (e.g., providing a user password or PIN in addition to a fingerprint).

Further, different companies providing applications processing different tasks may have different policies based on the level of confidence. For instance, different financial institutions providing separate payment system applications performing payment transactions may set different payment authorization policies based on the level of confidence on a single electronic device hosting the authenticator 202. Accordingly, a single authenticator 202 can perform a biometric authentication for different application vendors, such as the financial institutions mentioned above, because those venders can control their own authentication policies based on the received level of confidence.

In one embodiment, when the authenticator 202 determines a match (e.g., based on the match score exceeding a threshold), the level of confidence is the match score itself, communicated along with the positive match result. Conventionally, the match score is used solely for the initial threshold decision of determining whether there is a match. Once the threshold decision is made, the match score is thrown away. However, in these embodiments of the disclosure, the match score is also used to communicate the level of confidence.

In another embodiment of this disclosure, instead of communicating a match score itself, the level of confidence is computed in a manner that compensates for different scales used for match scores by different biometric matching algorithms. The level of confidence may then be used by the application operating the payment system or other security system regardless of which biometric matching algorithm is used to compute the match score. Accordingly, the level of confidence provides an approach for qualification of the match result.

In another embodiment of this disclosure, the level of confidence is based on a comparison of the match score with the threshold. In certain embodiments, the comparison of the match score and the threshold is represented in percentage. One of the possible ways to calculate the level of confidence (LC) is as follows: the matcher generates the match score Sε[0, M], where M is the maximal match score, the threshold is T→0<T<M, and S≧T, then

$$L C = \frac{S - T}{M - T} * 100 \% \qquad ( 1 )$$

Using equation (1), if the matcher generates a match score equal to the threshold, then the LC is 0%, and if it generates a maximal score M, then the LC is 100%. An LC of 0% indicates a positive match result between the recently collected biometric sample from the user and the stored template with a very low level of confidence, indeed, a minimum level of confidence. Applications that receive this low LC may not provide access to the user based on that application's authentication policy, or require a further authentication such as providing a user password for the user authentication. An LC of 100% indicates a positive match result with a very high level of confidence, indeed, a maximum level of confidence. Applications that receive this high LC may provide access to the user based on that application's authentication policy.

Accordingly, this allows a single threshold to be set to the optimal number for a particular authenticator 202 that provides the desired level of usability/security and meets industry standards. Different applications performing different tasks, such as processing a payment transaction, may then use its own independent policy for payment authorization based on the LC received from the authenticator 202. For example, combining the payment transaction amount and type of the transaction, different fraud detection signals and the LC, the application can make a decision to approve or reject the payment transaction request.

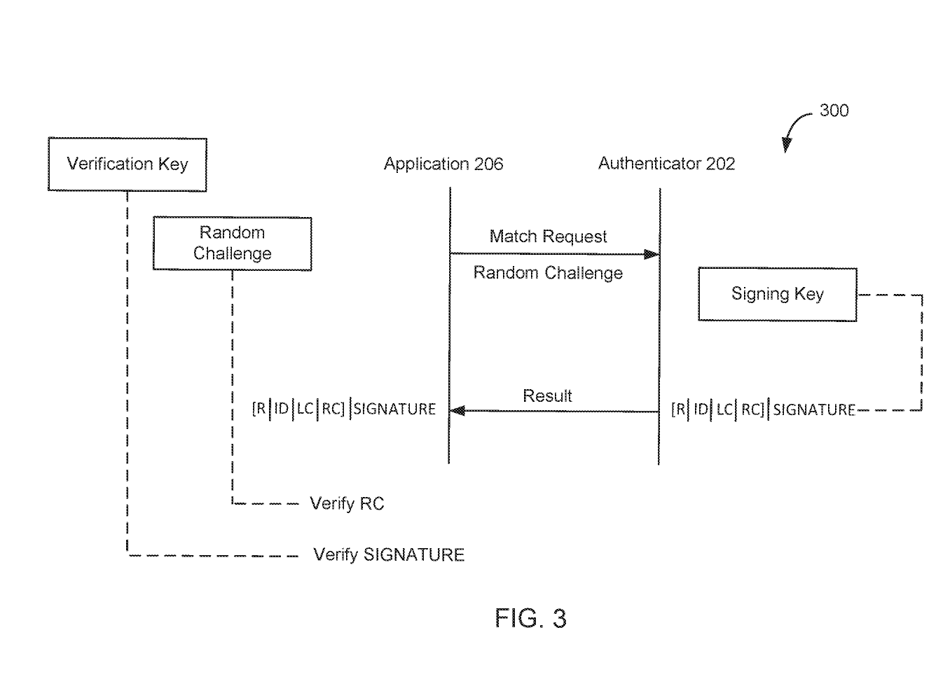

Additionally, as discussed above, communication of the match result and the LC to the application 206 requesting the biometric authentication may be over an untrusted communication channel 204. Accordingly, embodiments of the disclosure provide a method for securely communicating the match result and the LC to the application 206 from the authenticator 202 over the untrusted communication channel 204 regardless of whether the authenticator 202 and the application 206 are on a same device or devices remote from one another. FIG. 3 illustrates such a secure method 300 for communication between the authenticator 202 and the application 206 over the untrusted communication channel 204.

In the secure method 300, the authenticator 202 (see FIG. 2) must be trusted by the application 206. The authenticator 202 becomes trusted for the application 206 after performing a onetime provisioning operation, which as a result establishes “Signing” and “Verification” keys. The keys can be either symmetric or asymmetric. Also, in the secure method 300, the signor is the authenticator 202 and the verifier is the application 206.

In the secure method 300, the application 206 (see FIG. 2) generates a random challenge (RC), which in certain embodiments is a random sequence of bytes. The application 206 will then store the RC in a local storage and send another copy of the RC to the authenticator 202 along with the request for the biometric authentication. The authenticator 202 (see FIG. 2) performs the biometric authentication of the user and generates a match result (R), an identifier (ID) and the LC. In certain embodiments of the disclosure, the ID can be any one or more of the following data: a username or other identification information of the user; a technology-specific identifier (e.g. finger index for different fingers of a user, enrollment data hash for a fingerprint, etc.); or an additional cryptographic message/token.

The technology-specific identifier enables the application 206 (see FIG. 2) to perform different variations of the task based on the data in the identifier. For example, in embodiments where the application 206 is performing a mobile payment transaction, the technology-specific identifier, such as the finger index, may be utilized to indicate different sets of payment information for different users, and/or different sets of payment information for the same user based on the identified matched fingerprint (e.g., different fingers may correspond to different credit cards).

The authenticator 202 combines the R, ID, LC and RC to obtain system data. In certain embodiments of the disclosure, combining the R, ID, LC and RC is accomplished by concatenating the R, ID, LC and RC data. Subsequent to generating the system data, the authenticator 202 signs the system data with the Signing key to obtain signed system data represented by [R|ID|LC|RC]|SIGNATURE. The signed system data is then provided to the application 206 over the untrusted communication channel 204. The application 206 then (a) compares the RC received in the signed system data with the locally stored copy of the RC and (b) verifies the Signing key with the corresponding Verification key. If both (a) and (b) are satisfied, then the signed system data received over the untrusted communication channel 204 at the application 206 is considered valid. At this point, the application performing the task requesting the biometric authentication may make a final authentication decision based on the LC and its adopted security policy.

The LC is not required to be provided to the application using the secure method 300. Rather, in certain embodiments of the disclosure, the LC, along with any additional information, may be provided to the application through standard authentication methods.

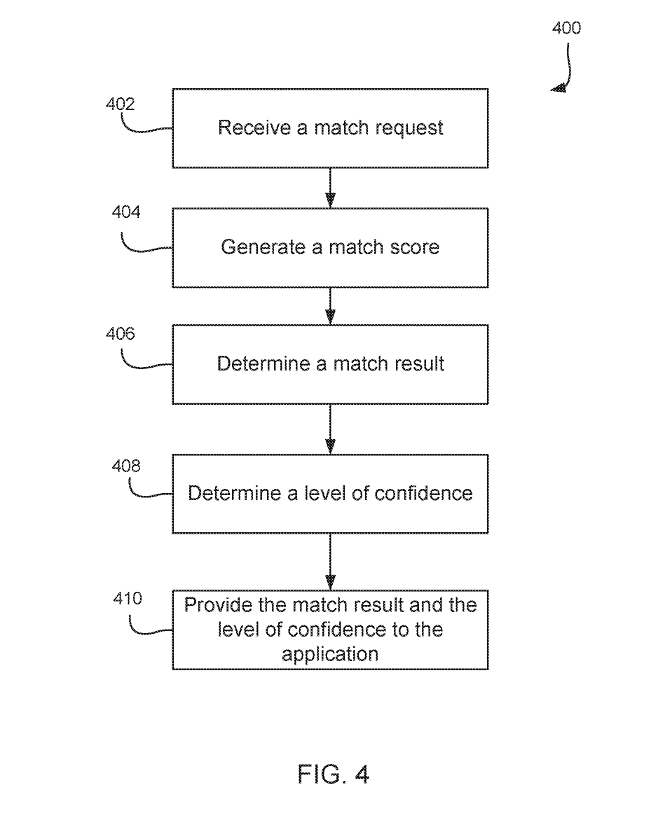

Turning now to FIG. 4, a flow chart 400 illustrates a method for the authenticator 202 (see FIG. 2) to provide a biometric authentication to the application 206 processing a task requesting the biometric authentication. At step 402, the authenticator 202 receives a match request from the application 206 processing the task. The match request is a request to the authenticator 202 to perform the biometric authentication by prompting a user to present a biometric object to the biometric sensor 102 (see FIG. 1) and capturing an image or images of the biometric object for comparison to a stored enrollment template.

Subsequently, at step 404, the authenticator 202 (see FIG. 2) determines a match score between the captured image or images of the biometric object and the stored enrollment template, and then, at step 406, determines a match result based on the match score. The authenticator 202 determines the match result by comparing the match score to a threshold value.

At step 408, the authenticator 202 (see FIG. 2) determines a level of confidence in the match result. The level of confidence is determined by comparing the match score to the threshold. In certain embodiments, the comparison between the match score and the threshold is represented as a percentage. Finally, at step 410, the authenticator 202 provides the match result and the level of confidence to the application 206.

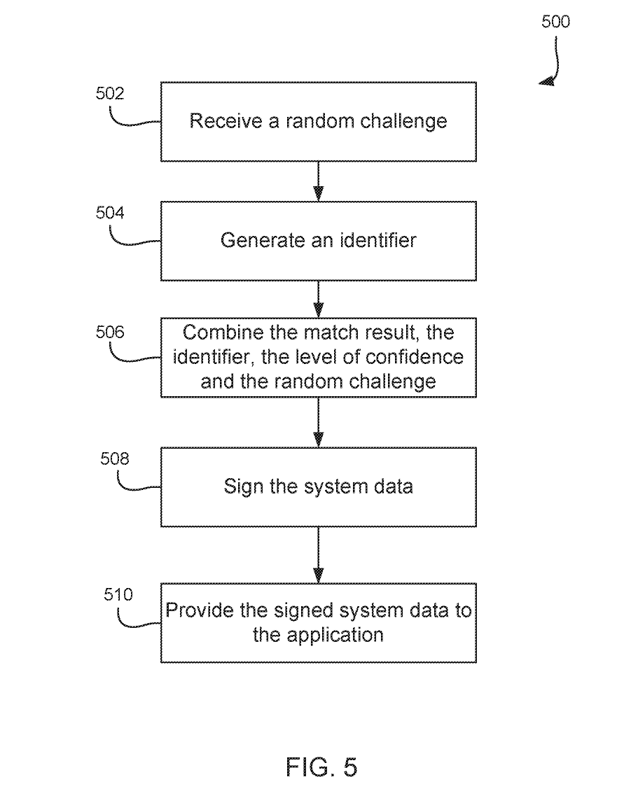

Turning now to FIG. 5, a flow chart 500 illustrates the application of the secure method 300 (see FIG. 3) in conjunction with providing the biometric authentication as illustrated in flow chart 400 (see FIG. 4). In this regard, step 502 is performed at the same time as step 402, and steps 504-510 comprise step 410 of FIG. 4.

At step 502, the authenticator 202 (see FIG. 2) receives a random challenge from the application 206 at the same time as receiving the match request. At step 504, the authenticator 202 generates an identifier. As discussed previously, the identifier, can be any one or more of the following data: a username or other identification information of the user; a technology-specific identifier (e.g. finger index, enrollment data hash for fingerprint, etc.); or an additional cryptographic message/token.

At step 506, the authenticator 202 (see FIG. 2) combines the match result (as determined at step 406 in flow chart 400 from FIG. 4), the identifier, the level of confidence (as determined at step 408 in flow chart 400 from FIG. 4) and the random challenge to obtain system data. In one embodiment of the disclosure, combining the match result, the identifier, the level of confidence and the random challenge comprises concatenating the match result, the identifier, the level of confidence and the random challenge.

Subsequently, at step 508, the authenticator 202 (see FIG. 2) signs the system data with the Signing key. And at step 510, the authenticator 202 provides the signed system data to the application 206. The application 206 then (a) compares the RC received in the signed system data with the locally stored copy of the RC and (b) verifies the Signing key with the corresponding Verification key. If both (a) and (b) are satisfied, then the signed system data received over the untrusted communication channel 204 at the application 206 is considered valid. At this point, the application performing the task requesting the biometric authentication may make a final authentication decision based on the LC and a security policy adopted by the application 206.

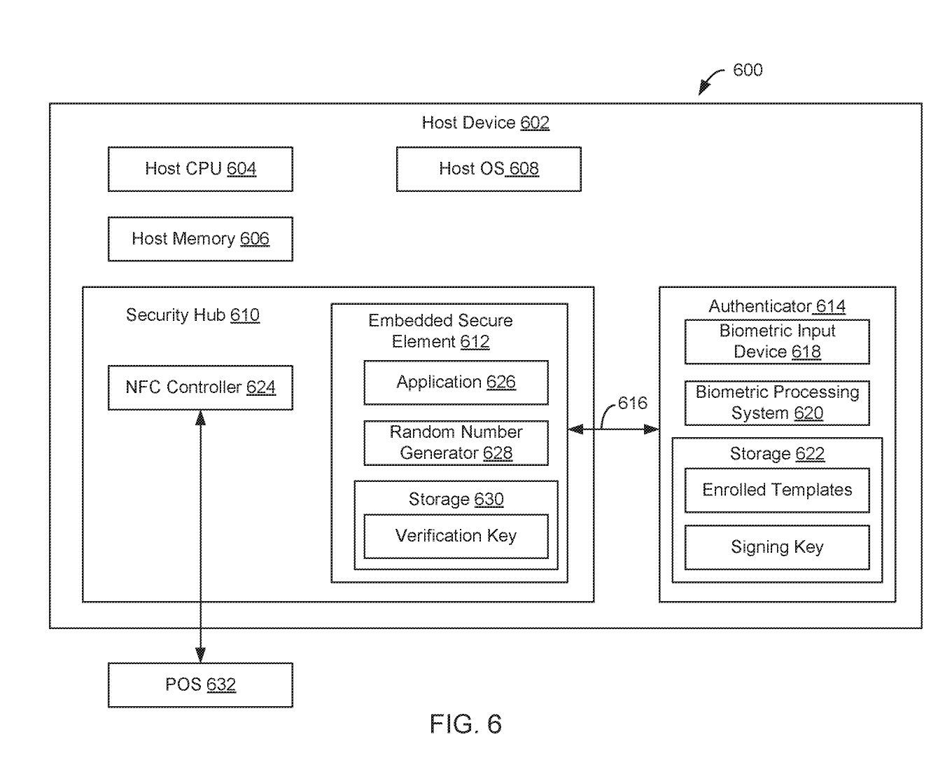

Turning now to FIGS. 6-8, other embodiments of this disclosure are depicted. FIGS. 6-8 illustrate various embodiments of the disclosure regarding the location of the authenticator and the application within a host device.

The embodiment depicted in FIG. 6 illustrates a system 600 including a host device 602 configured to perform secure transactions with devices and systems remote from the host device 602. The host device 602 includes a host central processing unit (CPU) 604 configured to implement functionality and/or process instructions for execution within the host device 602. The host device 602 further includes a host memory 606, which may be a non-transitory, computer-readable storage medium, configured to store information within the host device 602 during operation. The host device further includes a host operating system (OS) 608 that controls operations of the components of the host device 602.

The system 600 depicted in FIG. 6 may allow a biometric authentication to be easily and securely implemented in an untrusted environment (e.g., a host device susceptible to malicious attack) while protecting security sensitive data and ensuring authenticity of match results from the biometric authentication. In the illustrated embodiment, the host device 602 further includes a security hub 610 containing an embedded secure element (eSe) 612 in communication with a biometric authenticator 614. In some embodiments, a channel 616 between the authenticator 614 and the embedded secure element 612 is considered untrusted, and the processes described above with respect to FIGS. 1-5 are implemented between the authenticator 614 and the embedded secure element 612.

In the embodiment depicted in FIG. 6, the authenticator 614 includes a biometric input device 618. The biometric input device 618 is configured to capture a biometric sample from a user of the host device 602 for matching to a stored biometric enrollment template. In some embodiments, the biometric input device 618 is a fingerprint sensor, iris sensor, facial recognition image sensor, or other biometric sensor. The authenticator 614 also includes a biometric processing system 620 similar to the processing system 104 from FIG. 1. The authenticator 614 may also include a secure storage 622 for storing the biometric enrollment template and a Signing key acquired from an application during a provisioning process, as described above.

Further, in the illustrated embodiment, the authenticator 614, including the biometric input device 618, is depicted as part of the host device 602, but in another embodiment, it may be implemented remote from the host device. Regardless, upon receiving an authentication request from the embedded secure element 612, the authenticator 614 securely and reliably provides a biometric authentication result to the embedded secure element 612 over the channel 616. As discussed above in reference to FIGS. 2-5, the biometric authentication result may include a combination of a match result, an identifier, a random challenge and a level of confidence, which is signed with the Signing key prior to transmission over the channel 616 to the embedded secure element 612.

As illustrated, the security hub 610 includes the embedded secure element 612 and an NFC controller 624. In certain embodiments of the disclosure, the security hub 610 may be a payment hub configured to process a payment transaction for a payment system application. In this configuration, the payment hub is configured to securely store financial information of the user in the embedded secure element 612 of the host device 602 in order to process the payment transactions.

The embedded secure element 612 includes an application 626 performing a task that requests a biometric authentication from the authenticator 614. For example, in embodiments where the security hub 612 is configured as a payment hub, the task performed by the application 626 may be processing a payment transaction that requires a user authentication prior to processing.

The embedded secure element 612 further includes a random number generator 628 for generating a random challenge, as utilized by the secure method 300 from FIG. 3. The embedded secure element 612 also includes secure storage 630 that stores secure data locally. Also, in certain embodiments of the disclosure, the secure storage 630 may store any random challenge generated by the random number generator 628 and a Verification key created during a provisioning process between the authenticator 614 and the security hub 610. Both the random challenge and the Verification key are used to verify the biometric authentication result received from the authenticator 614, as described above regarding the secure method 300 (see FIG. 3).

In the embodiment of the disclosure where the application 626 is performing the payment transaction, the secure data stored in the secure storage 630 may include one or more sets of credit card information and/or other payment information, which may be released to a point of service (POS) 632 via the NFC controller 624 upon verification of the biometric match result from the authenticator 614. Further, in embodiments of the disclosure where the authenticator 614 is configured to communicate an identifier, such as a user identifier or a particular fingerprint identifier, the secure data may include different sets of payment information for different users, and/or different sets of payment information for the same user based on the identified matched fingerprint (e.g., different fingers may correspond to different credit cards). Further, in an embodiment in which a level of confidence is communicated to the embedded secure element, the security hub may, for example, require additional authentication data, such as an additional authentication factor (e.g., a password or PIN) and/or an additional biometric mode (e.g., facial recognition in addition to fingerprint) if the level of confidence is low.

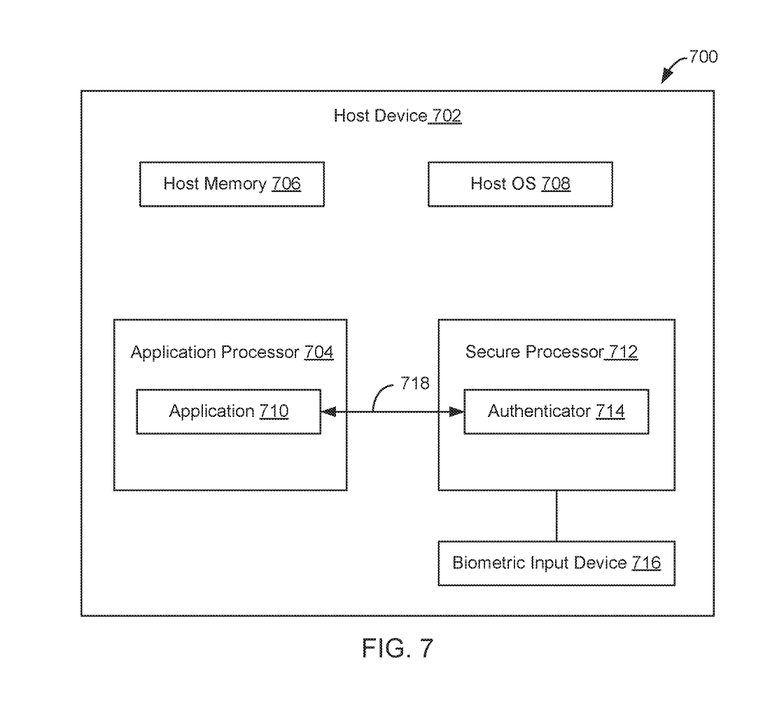

FIG. 7 illustrates a system 700 including a host device 702. The host device 702 is configured to perform secure transactions with devices and systems remote from the host device 702. In particular, host device 702 implements processes, as described above with respect to FIGS. 1-5, between processors residing within the host device 702. The host device 702 includes an application processor 704 that functions as a host central processing unit (CPU) and is configured to implement functionality and/or process instructions for execution within the host device 702. The host device 702 further includes a host memory 706, which may be a non-transitory, computer-readable storage medium, configured to store information within the host device 702 during operation. The host device 702 further includes a host operating system (OS) 708 that controls operations of the components of the host device 702.

The system 700 depicted in FIG. 7 may allow a biometric authentication to be easily and securely implemented in an untrusted environment (e.g., a host device susceptible to malicious attack) while protecting security sensitive data and ensuring authenticity of match results from the biometric authentication. In the illustrated embodiment, the host device 702 further includes a secure processor 712 that controls a biometric input device 716. The biometric input device 716 is configured to capture a biometric sample from a user of the host device 702 for matching to a stored biometric enrollment template. In some embodiments, the biometric input device 716 is a fingerprint sensor, iris sensor, facial recognition image sensor, or other biometric sensor. In certain embodiments of the disclosure, the secure processor 712 may be an application specific integrated circuit (ASIC) configured to determine a match score based an input biometric object, which may be a fingerprint image, an iris image, facial image, or other biometric object data for use during the biometric authentication.

In the illustrated embodiment, the application processor 704 is configured to perform an application 710 that may require a biometric authentication to be performed by an authenticator 714 of the secure processor 712, where the authenticator 714 is similar to authenticator 202 (see FIG. 2). The application 710 of the application processor 704 is in communication with the authenticator 714 of the secure processor 712 over communication channel 718. In some embodiments, the channel 718 between the authenticator 714 and the application 710 is considered untrusted, and the processes described above with respect to FIGS. 1-5 are implemented between the authenticator 714 and the application 710.

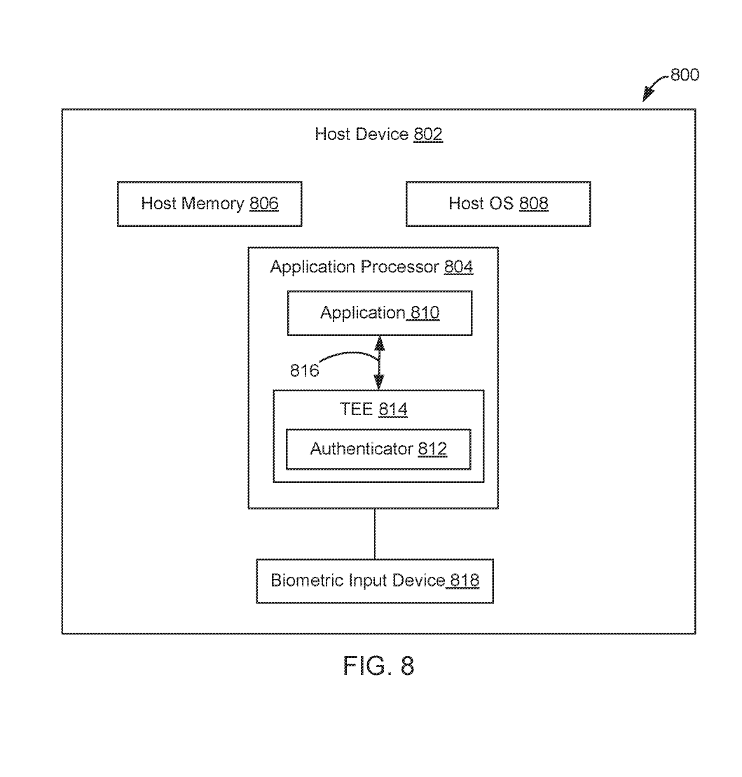

FIG. 8 illustrates a system 800 including a host device 802. The host device 802 is configured to perform secure transactions with devices and systems remote from the host device 802. In particular, the host device 802 implements processes, as described above with respect to FIGS. 1-5, within a processor residing within the host device 802.

The host device 802 includes an application processor 804 that functions as a host CPU and is configured to implement functionality and/or process instructions for execution within the host device 802. The host device 802 further includes a host memory 806, which may be a non-transitory, computer-readable storage medium, configured to store information within the host device 802 during operation. The host device 802 further includes a host operating system (OS) 808 that controls operations of the components of the host device 802.

The host device 802 further includes a biometric input device 818. The biometric input device 818 is configured to capture a biometric sample from a user of the host device 802 for matching to a stored biometric enrollment template. In some embodiments, the biometric input device 818 is a fingerprint sensor, iris sensor, facial recognition image sensor, or other biometric sensor. In the illustrated embodiment, biometric matching is performed by the application processor 804.

The system 800 depicted in FIG. 8 may allow a biometric authentication to be easily and securely implemented in an untrusted environment (e.g., a host device susceptible to malicious attack) while protecting security sensitive data and ensuring authenticity of match results from the biometric authentication. In the illustrated embodiment, the application processor 804 is configured to perform an application 810 that may require a biometric authentication to be performed by an authenticator 812, which is similar to the authenticator 202 (see FIG. 2). As illustrated, the authenticator 812 resides within a Trusted Execution Environment (TEE) 814 of the application processor 804. The TEE 814 of the application processor 804 defines a trusted environment within the application processor 804 to perform any biometric authentication required by the application 810.

As illustrated, the application 810 is in communication with the authenticator 812 over communication channel 816. In some embodiments, the channel 816 between the authenticator 812 and the application 810 is considered untrusted, and the processes described above with respect to FIGS. 1-5 are implemented between the authenticator 812 and the application 810.

The embodiments and examples set forth herein were presented in order to best explain the present disclosure and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method for an authenticator to provide a secure biometric authentication for a task, the method comprising:
receiving a match request from an application processing the task;
generating a match score based on a comparison between biometric input data captured by a sensor associated with the authenticator and stored enrollment data;
determining a match result based on the match score;
determining a level of confidence in the match result; and
providing the match result and the level of confidence to the application processing the task.

2. The method of claim 1, wherein the level of confidence is the match score.

3. The method of claim 1, wherein both determining the match result and the level of confidence comprises comparing the match score to a threshold.

4. The method of claim 3, wherein the comparison between the match score and the threshold to determine the level of confidence is represented as a percentage.

5. The method of claim 1, further comprising receiving a random challenge from the application at the same time as the match request.

6. The method of claim 5, further comprising generating an identifier relating to a user of the authenticator, wherein the providing the match result and the level of confidence to the application processing the task comprises:
combining the match result, the level of confidence, the random challenge and the identifier into system data;
signing the system data with a signature key to obtain signed system data; and
providing the signed system data to the application.

7. The method of claim 5, wherein the identifier provides an identification of the user of the authenticator.

8. The method of claim 7, wherein the signature key is an asymmetric key.

9. The method of claim 7, wherein the random challenge is a random sequence.

10. The method of claim 7, wherein the application is implemented in an embedded secure element.

11. The method of claim 1, wherein the authenticator is provided by a secure processor of a device associated with the authenticator, and the device includes an application processor separate from the secure processor.

12. The method of claim 11, wherein the secure processor controls the sensor.

13. The method of claim 1, wherein the authenticator is provided by a Trusted Execution Environment (TEE) of an application processor of a device hosting the authenticator.

14. A device for providing a secure biometric authentication for a task, the device comprising:
a biometric sensor; and
a processing system including an authenticator configured to:
receive a match request from an application processing the task;
generate a match score based on a comparison between biometric input data captured by a sensor associated with the authenticator and stored enrollment data;
determine a match result based on the match score;
determine a level of confidence in the match result; and
provide the match result and the level of confidence to the application processing the task.

15. The method of claim 14, wherein the level of confidence is determined by comparing the match score with a threshold.

16. The method of claim 14, wherein the processing system includes an application processor and a secure processor separate from the application processor and the secure processor provides the authenticator and controls the biometric sensor.

17. The method of claim 14, wherein the processing system includes an application processor and the application processor includes a Trusted Execution Environment (TEE) that provides the authenticator.

18. A system providing a secure biometric authentication for a task, the system comprising:
an application processing the task; and
an authenticator, wherein the authenticator is configured to:
receive a match request from the application;
generate a match score based on a comparison between biometric input data captured by a sensor associated with the authenticator and stored enrollment data;
determine a level of confidence in the match score; and
provide the level of confidence to the application.

19. The system of claim 19, wherein the level of confidence is determined by comparing the match score with the threshold.

20. The system of claim 19, wherein the application is implemented in an embedded secure element of a host device for the application, and the task is a payment transaction.
